(19) United States
(12) Patent Application Publication
(10) Pub. No.: US 2025/0115049 A1
(43) Pub. Date: Apr. 10, 2025

(54) Arrangement and Method for Supplying a Print Head Cleaning Unit of an Inkjet Printing Device with a Cleaning Fluid

(71) Applicant: Canon Production Printing Holding B.V., Venlo (NL)

(72) Inventors: Jochen Reinders, Isen (DE); Sergej Litovkin, Augsburg (DE)

(21) Appl. No.: 18/906,343

(22) Filed: Oct. 4, 2024

(30) Foreign Application Priority Data
Oct. 5, 2023 (DE) 10 2023 127 148.2

(51) Int. Cl. B41J 2/165

(52) U.S. Cl. CPC B41J 2/16552; B41J 2002/16573; B41J 2002/16594

(57) ABSTRACT

In an arrangement for supplying a print head cleaning unit of an inkjet printing device with a cleaning fluid, a supply line is provided that can be connected at least with the print head cleaning unit. A cleaning fluid can be fed to the print head cleaning unit via the supply line. Furthermore, the arrangement includes a pump for transporting the cleaning fluid at least through the supply line. The cleaning fluid can be fed to the transport means via an infeed line. The arrangement also includes a sensor for determining the conductivity of the cleaning fluid in the infeed line.

### CROSS-REFERENCE TO RELATED APPLICATION

This application claims priority to German Patent Application No. 10 2023 127 148.2 filed Oct. 5, 2023, the disclosure of which is hereby incorporated by reference in its entirety.

### BACKGROUND OF THE INVENTION

### Field of the Invention

The invention relates to an arrangement or system for supplying a print head cleaning unit of an inkjet printing device with a cleaning fluid. Furthermore, the invention relates to a method for controlling the arrangement.

### Field of the Invention

Inkjet printing devices generally comprise print heads with which ink is applied onto a recording medium. In order to provide a consistently high quality, print heads must be cleaned regularly. For example, for this purpose print heads can be flushed with a cleaning fluid and with the aid of a print head cleaning unit. It is thereby important that only cleaning fluids be used that are matched to the print heads and/or the ink being used. In the event that other cleaning fluids are used, it may lead to reactions of the cleaning fluid with the print heads and/or the ink being used, and thus the print heads may become clogged or damaged.

Known achievements to avoid this damage to printing devices utilize barcodes or RFID tags that are applied to cleaning fluid containers and comprise information regarding the contained fluid. Given the installation of such a container in a printing device, the barcodes or RFID tags can be read out in order to ensure that only those fluids are used that are compatible with the respective printing device and the ink being used.

However, given such solutions it is disadvantageous that the content of a cleaning fluid container is not tested; only the tag is checked. Damage to the printing device can nevertheless occur given damage to the tag, given an incorrectly applied tag, or given contamination of the cleaning fluid.

### SUMMARY OF THE INVENTION

It is the object of the invention to specify an arrangement or system for supplying a print head cleaning unit of an inkjet printing device with a cleaning fluid that ensures an increased safety against damage of the inkjet printing device due to unsuitable cleaning fluids.

This object is achieved via an arrangement or system and method having the features disclosed herein.

Given an arrangement or system for supplying a print head cleaning unit of an inkjet printing device with a cleaning fluid, according to a first aspect a supply line is provided that can be connected with at least the print head cleaning unit. A cleaning fluid can be supplied to the print head cleaning unit via the supply line. Furthermore, the arrangement comprises a means for transporting the cleaning fluid at least through the supply line, wherein the cleaning fluid can be supplied to the transport means via an infeed line. The arrangement also comprises a means for determining a conductivity of the cleaning fluid in the infeed line.

The conductivity is in particular an electrical conductivity. The means for determining a conductivity of the cleaning fluid is thus in particular a sensor with which the electrical conductivity of the cleaning fluid can be determined. For example, the sensor can be an inductive or conductive sensor.

The means for transporting the cleaning fluid can be a cleaning fluid pump, for example. In a cleaning operating mode, the transport means in particular firstly transports the cleaning fluid through the infeed line; the cleaning fluid subsequently flows through the transport means, and then through the supply line to the print head cleaning unit. The infeed line can be fed from a cleaning fluid reservoir, for example. The arrangement preferably comprises the print head cleaning unit.

Print images in the form of dots can be applied onto recording media with the aid of a print head of an inkjet printing device. Inkjet printing devices regularly comprise a plurality of print heads. An inkjet printing device is known from the document DE 10 2014 106 424 A1, for example.

Print heads comprise a plurality of print nozzles, wherein each print nozzle can apply ink droplets of a variable volume in the form of dots onto the recording medium. In practice, each print head can comprise multiple hundreds to multiple thousands of print nozzles directed toward the recording medium. In order to ensure a consistent print quality, for example to prevent or remedy clogged print nozzles, print heads are cleaned—in particular flushed—regularly or as needed with the aid of cleaning fluids.

Fluids, for example inks and cleaning fluids, can normally be differentiated using their conductivity. For example, a concentrated aqueous solution of an electrolyte normally has a higher conductivity than tap water, and tap water in turn normally has a higher conductivity than organic solvent. These various fluids are normally also not miscible with one another, such that they do not mix to form a homogeneous phase. Furthermore, components dissolved in a fluid can precipitate out upon mixing with an additional fluid. Therefore, mixing of fluids that are not matched to one another is often to be avoided. Furthermore, deviations from an expected conductivity of a fluid might indicate unwanted contamination of the fluid.

The arrangement or system enables the conductivity of the cleaning fluid being used to be determined with certainty, in particular before the cleaning fluid arrives in a print head or before the cleaning fluid mixes with an ink of the inkjet printer. It can thus be avoided that a cleaning fluid is used that is not matched to the ink or the material of the print head. Contaminated cleaning fluids can also be determined in this way. The described unwanted effects can thus be avoided, for example.

The means for determining the conductivity is preferably arranged at a measurement point along the infeed line, and the infeed line forms a first segment of the infeed line between the measurement point and the transport means. The means for determining the conductivity thus determines the conductivity of the cleaning fluid in the infeed line, at least at the measurement point. The means for determining the conductivity is thus before the transport means in the flow direction of the cleaning fluid, at least in the cleaning operating mode, so that the cleaning fluid first flows past the means for determining the conductivity and afterward flows through the transport means. It is thereby achieved that the conductivity can be determined especially quickly.

It is especially preferred that the first segment of the infeed line is at least so long that the fluid transported through the first segment only reaches the transport means if a conductivity measurement result is present. Wherein the conductivity measurement result is determined with the aid of the means for determining the conductivity. In particular, the length of the first segment of the infeed line is dependent on: a cross sectional area (m2) of the first segment of the infeed line; a delivery rate (m3/s) of the cleaning fluid through the first segment of the infeed line, as generated by the transport means; and a time(s) required for the measurement of the conductivity and reaction of the transport means. The transport means can thus be deactivated as soon as a conductivity measurement result of a cleaning fluid being transported for the first time in the arrangement is established that deviates from an expected conductivity, and without the cleaning fluid already having been transported in the transport means or in the supply line. For example, after a deactivation of the transport means, the infeed line with the discrepant cleaning fluid can simply be swapped out or cleaned. A further propagation or penetration of the discrepant cleaning fluid into the arrangement or the print head cleaning unit or a print head is thus avoided.

The infeed line is preferably reversibly connected with the transport means. This enables the simple swapping of the infeed line.

The arrangement or system furthermore preferably comprises a cleaning fluid reservoir, and the infeed line is connected with the cleaning fluid reservoir. This enables a simple storage and supplying of the cleaning fluid.

The arrangement or system furthermore comprises a return line, and that at least the return line, the cleaning fluid reservoir, the means for transporting the cleaning fluid, and the infeed line with the means for determining the conductivity form a cleaning fluid circuit. The cleaning fluid can be transported within the cleaning fluid circuit with the aid of the transport means. This can also be implemented repeatedly or for a defined time. It is thereby achieved that, with the aid of the means for determining the conductivity, the conductivity of the cleaning fluid is determined especially precisely and without consuming the cleaning fluid. In particular, the infeed line can thereby also be of particularly short design. Furthermore, the cleaning fluid circuit can thereby be particularly simple to flush in the event that an unwanted cleaning fluid has previously been transported in the infeed line.

In a measurement operating mode, a control unit or controller of the arrangement or system drives the means for transporting the cleaning fluid to transport said cleaning fluid through the cleaning fluid circuit. It is thereby achieved that, with the aid of the means for determining the conductivity, the conductivity of the cleaning fluid is determined particularly precisely and without consuming the cleaning fluid.

In a cleaning operating mode, the control unit or controller of the arrangement or system drives at least the means for transporting the cleaning fluid in order to transport said cleaning fluid to the print head cleaning unit. It is thereby achieved that the cleaning fluid can be transported directly to the print head cleaning unit.

Wherein the arrangement preferably comprises a valve that, in a first valve position, connects the means for transporting the cleaning fluid and the return line so that the cleaning fluid can be transported only through the cleaning fluid circuit and, in a second valve position, connects the means for transporting the cleaning fluid with the supply line or the print head cleaning unit so that the cleaning fluid can be directed only to the supply line or to the print head cleaning unit. This enables the especially secure separation of the cleaning fluid circuit from the supply line or the print head cleaning unit. Furthermore, the cleaning fluid circuit can thereby be flushed especially simply in the event that an unwanted cleaning fluid has previously been transported in the infeed line. The valve can be a 3/2-way valve, for example.

In a further aspect, a method is provided for controlling an arrangement for supplying a print head cleaning unit of an inkjet printing device with a cleaning fluid. In the method, the cleaning fluid is transported at least through an infeed line with the aid of the transport means, and the conductivity of the cleaning fluid in the infeed line is determined with the aid of a means for determining the conductivity of the cleaning fluid. Furthermore, the means for transporting the cleaning fluid is deactivated if the determined conductivity of the cleaning fluid deviates from a preset conductivity value, or from a conductivity range. This enables a particularly safe use of cleaning fluids. The preset conductivity value or range can, for example, be dependent on the ink used in the inkjet printing device.

In a further aspect, a further method is provided for controlling an arrangement for supplying a print head cleaning unit of an inkjet printing device with a cleaning fluid. In the further method, the cleaning fluid is transported through the cleaning fluid circuit with the aid of the transport means; in particular, the valve is brought into the first valve position. The cleaning fluid is preferably transported for a preset volume or a preset time. Furthermore, in the method, the conductivity of the cleaning fluid in the infeed line is determined with the aid of a means for determining the conductivity of the cleaning fluid. The valve is also switched into a second valve position in which the means for transporting the cleaning fluid is connected to a supply line if the determined conductivity of the cleaning fluid is at a preset conductivity value or within a preset conductivity range. The cleaning fluid can thus be transported in the direction of the print head cleaning unit after successful determination and suitability. In the event that the conductivity subsequently deviates from the preset conductivity, in particular the transport means can be deactivated, for example according to the aforementioned method, or the valve can be switched into the first valve position.

The methods can be developed in the same manner as the arrangement, in particular with the features of the dependent claims or corresponding method features. The technical advantages achieved with the methods coincide with those that are explained in connection with the arrangement according to the invention.

### BRIEF DESCRIPTION OF THE DRAWINGS

The terms Fig., Figs., Figure, and Figures are used interchangeably in the specification to refer to the corresponding figures in the drawings.

Exemplary embodiments are described in the following using drawings. Shown are:

FIG. 1 shows a schematic depiction of a first arrangement for supplying a print head cleaning unit of an inkjet printing device with a cleaning fluid, and

FIG. 2 shows a schematic depiction of a second arrangement for supplying a print head cleaning unit of an inkjet printing device with a cleaning fluid.

The exemplary embodiments of the present disclosure will be described with reference to the accompanying drawings. Elements, features and components that are identical, functionally identical and have the same effect are—insofar as is not stated otherwise-respectively provided with the same reference character.

### DESCRIPTION OF THE INVENTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

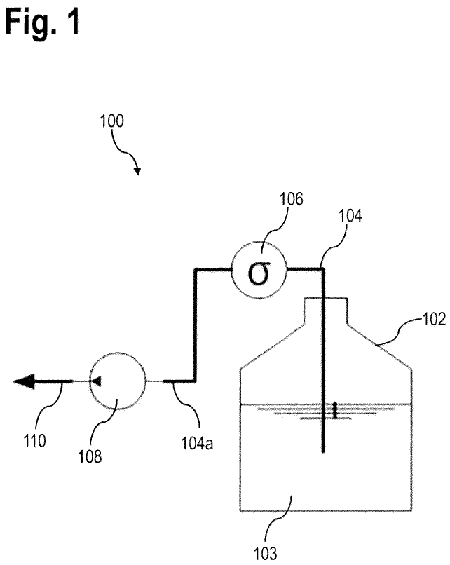

FIG. 1 shows a schematic depiction of a first arrangement or system 100 for supplying a print head cleaning unit of an inkjet printing device with a cleaning fluid. The arrangement or system 100 comprises a cleaning fluid reservoir 102 that stores a cleaning fluid 103; an infeed line 104; a means 106 for determining a conductivity of the cleaning fluid 103; a means 108 for transporting the cleaning fluid 103; and a supply line 110.

The means 106 for determining the conductivity of the cleaning fluid 103 is in particular a conductivity sensor 106 with the aid of which the electrical conductivity of the cleaning fluid 103 can be determined. The sensor 106 is arranged at or in the infeed line 104 so that the sensor 106 can determine the conductivity of the cleaning fluid 103 located in the infeed line 104.

The means 108 for transporting the cleaning fluid 103 is in particular a pump 108. The pump 108 in particular conveys the cleaning fluid 103 through the infeed line 104 and the supply line 110, and thus in the direction of the print head cleaning unit.

In particular, the sensor 106 determines the conductivity at least at a measurement point at or in the infeed line 104. The measurement point is thereby arranged along the infeed line 10, and the infeed line 104 forms a first segment 104a of the infeed line between the measurement point and the pump 108. The length of the first segment 104a is in particular to be dimensioned so that, depending on a cross sectional area (m2) of the first segment 104a of the infeed line 104, on a delivery rate (m3/s) of the cleaning fluid 103 through the first segment 104a as generated by the pump 108, and on a time(s) required for the measurement of the conductivity and control of the pump 108. The pump 108 can thus be deactivated as soon as a conductivity measurement result of a cleaning fluid 103 transported for the first time in the arrangement 200 that deviates from an expected conductivity is established. The pump 108 can thereby be deactivated without the cleaning fluid 103 having already been transported into the pump 108 or into the supply line 110. For example, after the pump 108 is deactivated, the infeed line 104 with the discrepant cleaning fluid 103 can simply be exchanged or cleaned. A further propagation or penetration of the discrepant cleaning fluid 104 into the arrangement 100 or the print head cleaning unit or a print head is thus avoided.

The arrangement 100 can thus be controlled so that the cleaning fluid 103 is initially pumped from the cleaning fluid reservoir 102 through the infeed line 104 with the aid of the pump 108. The conductivity of the cleaning fluid 103 can then be determined with the aid of the sensor 106 and, given a deviation of the measured conductivity from a preset conductivity, the pump 108 can be controlled so that it does not pump. If the measured conductivity corresponds to the preset conductivity or is within a preset conductivity range, the pump 108 can then be driven so that it continues to pump.

In an exemplary embodiment, a control unit or controller (not shown) is operatively connected to the sensor 106 and the pump 108 and receives a signal from the sensor 106 indicative of the conductivity of the cleaning fluid 103. The control unit or controller includes processing circuitry that is configured to perform one or more functions and/or operations of the control unit or controller, including determining a deviation of the measured conductivity from a preset conductivity and controlling the pump 108 so that it does not pump if a deviation is present. In an exemplary embodiment, the control unit or controller includes a memory configured to store data/information, and/or store executable code that is executable by the processing circuitry.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general-purpose computer.

For the purposes of this discussion, the term “processing circuitry” shall be understood to be circuit(s) or processor(s), or a combination thereof. A circuit includes an analog circuit, a digital circuit, data processing circuit, other structural electronic hardware, or a combination thereof. A processor includes a microprocessor, a digital signal processor (DSP), central processor (CPU), application-specific instruction set processor (ASIP), graphics and/or image processor, multi-core processor, or other hardware processor. The processor may be “hard-coded” with instructions to perform corresponding function(s) according to aspects described herein. Alternatively, the processor may access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, the memory is any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

It is thus prevented that cleaning fluid 103 that does not have the desired, preset conductivity does not arrive in the print head cleaning unit and does not arrive in the print head.

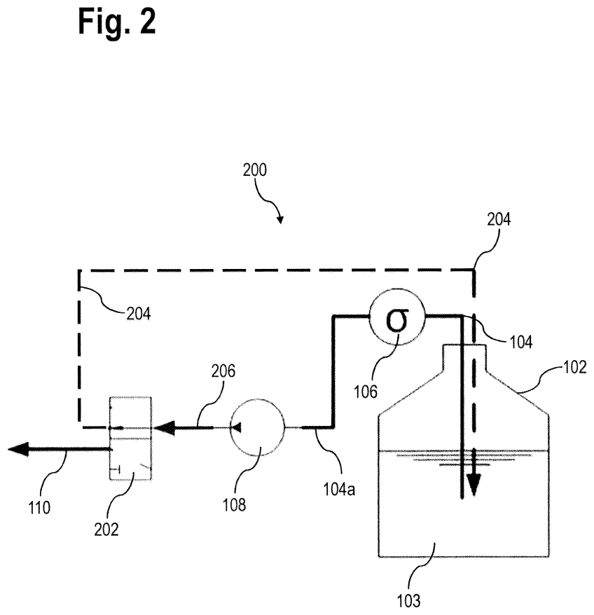

FIG. 2 shows a schematic depiction of a second arrangement 200 for supplying a print head cleaning unit of an inkjet printing device with the cleaning fluid 103. Elements having the same design or the same function have the same reference characters.

In addition to the already in conjunction with the arrangement 100 shown in FIG. 1, the arrangement or system 200 comprises a valve 202 and a return line 204. With the aid of the valve 202, the cleaning fluid 103 conveyed by the pump 108 can be conducted either into the supply line 110 or into the return line 204. The valve 202 can be connected with the pump 108 with a connection line 206, or directly with the pump 108. The return line 204 is connected with the valve 202 and the cleaning fluid reservoir 102. The valve 202 can be a 3/2-way valve, for example.

The valve 202, the return line 204, the cleaning fluid reservoir 102, the infeed line 104, the pump 108, and the connection line 206 form a cleaning fluid circuit. If the valve 202 is in a first valve position, the cleaning fluid 103 can circulate in the cleaning fluid circuit, in particular with the aid of the pump 108. The cleaning fluid 103 thereby flows through the infeed line 104 and past the sensor 106. The cleaning fluid 103 flows further through the pump 108, the connection line 206, the valve 202, and the return line 204, back into the cleaning fluid reservoir 102.

In a second valve position of the valve 202, the connection line 206 is connected with the supply line 110, and the cleaning fluid 103 can be transported from the cleaning fluid reservoir 102 in the direction of the print head cleaning unit with the aid of the pump 108.

The arrangement or system 200 can be controlled so that, upon feeding in new cleaning fluid 103, the valve 202 is initially in the first valve position, and the pump 108 pumps the cleaning fluid 103 through the cleaning fluid circuit. The conductivity of this cleaning fluid 103 can thereby be determined. In particular, the pump 108 is controlled so that the cleaning fluid 103 is pumped through the cleaning fluid circuit for a defined time period, or is pumped through the cleaning fluid circuit until the sensor 106 has determined a stable conductivity measurement result. If the determined conductivity measurement result corresponds to the preset conductivity or is within a preset conductivity range, the valve 202 can then be brought into the second valve position. The cleaning fluid 103 is thereby pumped to the print head cleaning unit. In the event that the conductivity measurement result deviates from the preset conductivity, the pump 108 can be stopped, and the valve 202 remains in its first valve position. It can thereby be safely prevented that unwanted or unsuitable cleaning fluid 103 is pumped to the print head cleaning unit.

Even if the valve 202 has already been placed into the second valve position, the conductivity of the conveyed cleaning fluid 103 can continue to be determined with the aid of the sensor 106 and compared with the preset conductivity value. Given a deviation, the pump 108 can then be stopped and/or the valve 202 can be set back into the first valve position.

In the event that a deviation of the conductivity is established, the affected elements—in particular the infeed line 104—can then be cleaned or exchanged.

To enable those skilled in the art to better understand the solution of the present invention, the technical solution in the embodiments of the present invention is described clearly and completely above in conjunction with the drawings in the embodiments of the present invention. Obviously, the embodiments described are only some, not all, of the embodiments of the present inventions. All other embodiments obtained by those skilled in the art on the basis of the embodiments in the present invention without any creative effort should fall within the scope of protection of the present invention.

### REFERENCE LIST

100, 200 arrangement or system for supplying a print head cleaning unit with a cleaning fluid
102 cleaning fluid reservoir
103 cleaning fluid
104 infeed line
104a first segment of the infeed line
106 means for determining the conductivity
108 means for transporting the cleaning fluid
110 supply line
202 valve
204 return line

1. An arrangement to supply a print head cleaning unit of an inkjet printing device with a cleaning fluid, the arrangement comprising:
a supply line connected at least with the print head cleaning unit and via which a cleaning fluid is fed to the print head cleaning unit;
a means for transporting the cleaning fluid at least through the supply line, wherein the cleaning fluid is fed to the transport means via an infeed line; and
a means for determining the conductivity of the cleaning fluid in the infeed line.

2. The arrangement according to claim 1, wherein the means for determining the conductivity is arranged at a measurement point along the infeed line, and the infeed line forms a first segment of the infeed line between the measurement point and the transport means.

3. The arrangement according to claim 2, wherein the first segment of the infeed line is at least so long that the cleaning fluid transported through the first segment only reaches the transport means if a conductivity measurement result is present.

4. The arrangement according to claim 1, further comprising a cleaning fluid reservoir, and the infeed line is connected with the cleaning fluid reservoir.

5. The arrangement according to claim 4, further comprising a return line, and at least the return line, the cleaning fluid reservoir, the means for transporting the cleaning fluid, and the infeed line with the means for determining the conductivity form a cleaning fluid circuit.

6. The arrangement according to claim 5, in which, in a measurement operating mode, a control unit of the arrangement drives the means for transporting the cleaning fluid to transport said cleaning fluid through the cleaning fluid circuit.

7. The arrangement according to claim 6, in which, in a cleaning operating mode, the control unit of the arrangement drives at least the means for transporting the cleaning fluid in order to transport said cleaning fluid to the print head cleaning unit.

8. The arrangement according to claim 5, further comprising a valve that, in a first valve position, connects the means for transporting the cleaning fluid and the return line so that the cleaning fluid is transported through the cleaning fluid circuit, and, in a second valve position, connects the means for transporting the cleaning fluid with the supply line so that the cleaning fluid is fed to said supply line.

9. A method for controlling an arrangement according to claim 1, the method comprising:
transporting the cleaning fluid at least through the infeed line with the aid of the transport means;
determining the conductivity of the cleaning fluid in the infeed line with the aid of a means for determining the conductivity of the cleaning fluid; and
deactivating the means for transporting the cleaning fluid if the determined conductivity of the cleaning fluid deviates from a preset conductivity value.

10. The method for controlling an arrangement according to claim 8,
transporting the cleaning fluid through a cleaning fluid circuit with the aid of the transport means,
determining the conductivity of the cleaning fluid in the infeed line with the aid of a means for determining the conductivity of the cleaning fluid, and
switching a valve into a second valve position in which the means for transporting the cleaning fluid is connected to the supply line if the determined conductivity of the cleaning fluid is at the preset conductivity value.

11. A system for supplying a print head cleaning unit of an inkjet printing device with a cleaning fluid, the system comprising:
a supply line connected at least with the print head cleaning unit and via which a cleaning fluid is fed to the print head cleaning unit;
a cleaning fluid pump configured to transport the cleaning fluid at least through the supply line, wherein the cleaning fluid is fed to the cleaning fluid pump via an infeed line;
a sensor positioned at a measurement point along the infeed line and configured to determine a conductivity of the cleaning fluid in the infeed line; and
a controller operatively connected to the sensor and the cleaning fluid pump and configured to:
receive a signal from the sensor indicative of a measured conductivity value of the cleaning fluid in the infeed line;
determine a deviation of the measured conductivity value of the cleaning fluid from a preset conductivity value; and
deactivating the pump if the measured conductivity value of the cleaning fluid deviates from the preset conductivity value.

12. The system according to claim 11, wherein the infeed line forms a first segment of the infeed line between the measurement point and the pump.

13. The system according to claim 12, wherein the first segment of the infeed line is at least so long that the cleaning fluid transported through the first segment only reaches the pump if the deviation of the measured conductivity value of the cleaning fluid from the preset conductivity value is not present.

14. The system according to claim 11, further comprising a cleaning fluid reservoir, wherein the infeed line is connected with the cleaning fluid reservoir.

15. The system according to claim 14, further comprising a return line, and at least the return line, the cleaning fluid reservoir, the pump, and the infeed line with the sensor for determining the conductivity form a cleaning fluid circuit.

16. The system according to claim 15, further comprising a valve that, in a first valve position, connects the pump and the return line so that the cleaning fluid is transported through the cleaning fluid circuit, and, in a second valve position, connects the pump with the supply line so that the cleaning fluid is fed to the supply line.

17. The system of claim 16, wherein the controller is operatively connected to the valve and further configured to:
switch the valve into the second valve position in which the pump is connected to the supply line if the measured conductivity of the cleaning fluid is at the preset conductivity value.
